(19) United States
(12) Patent Application Publication
(10) Pub. No.: US 2026/0352983 A1
(43) Pub. Date: Nov. 5, 2026

(54) ULTRASONIC COMMUNICATION USING A BUSBAR

(71) Applicant: Dell Products L.P., Round Rock, TX (US)

(72) Inventors: SANDOR TIBOR FARKAS, Round Rock, TX (US); MICHAEL J. STUMPF, Cedar Park, TX (US); KEVIN WARREN MUNDT, Austin, TX (US); TIMOTHY M. LAMBERT, Austin, TX (US)

(21) Appl. No.: 19/194,359

(22) Filed: Apr. 30, 2025

(51) Int. Cl. H04Q 1/06; H04Q 1/02

(52) U.S. Cl. CPC H04Q 1/068; H04Q 1/03

(57) ABSTRACT

Methods, systems, and devices are provided for managing operation of a rack that may house data processing systems. To manage operation of the rack, current flow measurements of current along a length of a bus bar of the rack may be obtained and used to identify relative placements of data processing systems that draw power from the bus bar and power shelves that supply the power to the bus bar. The relative placements may be used to make a determination regarding operation of the rack has exceeded system limits. Based on the determination indicating the rack has exceeded the system limits, a remediation process may be performed to mitigate impacts of the operation of the rack beyond the operating limits. By doing so, the likelihood of negative impacts of overloading the rack system may be reduced and the provisioning of desired computer implemented services may be facilitated.

### FIELD

Embodiments disclosed herein relate generally to management of data processing systems. More particularly, embodiments disclosed herein relate to systems and methods for mitigating damage to data processing systems.

### BACKGROUND

Computing devices may provide computer implemented services. The computer implemented services may be used by users of the computing devices and/or devices operably connected to the computing devices. The computer implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a diagram illustrating a portion of a busbar in accordance with an embodiment.

FIGS. 2B-2C show diagrams illustrating a bar clip in accordance with an embodiment.

FIG. 2D shows a diagram illustrating a bar clip and a busbar in accordance with an embodiment.

FIGS. 2E-2F show diagrams illustrating a system in accordance with an embodiment.

FIG. 2G shows an interaction diagram in accordance with an embodiment.

FIG. 3 shows a flow diagram illustrating a method for managing operation of data processing systems positioned in a rack in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems that may provide, at least in part, computer implemented services. The computer-implemented services may be provided to any type and/or number of other devices and/or users of the data processing systems. Furthermore, the provided computer implemented services may be of any quantity and/or type of such services.

To provide the computer implemented services, the data processing systems may include hardware components. For example, operation of these hardware components may facilitate various functionalities of a data processing system of the data processing systems, thereby causing the data processing system to provide the computer implemented services.

To enable such operation of the hardware components, the hardware components may consume power required for such operation. This power may be provided by at least one power supply unit, such as any number of power supply units positioned with a power shelf to provide power to a power bus (e.g., busbar 110), the power bus then redistributing that power to any number of data processing systems housed in chassis positioned in a rack of a rack system. For example, the power supply units may receive alternating current “AC” and may convert the AC to direct current “DC” in order to provide to a power bus to supply power to data processing systems housed in chassis positioned in the rack.

However, the direct current supplied to the data processing system via the power bus may exceed the operation limits of the power bus. For example, the power bus may be capable of supplying a specific amount of power (e.g., direct current) to data processing systems in the rack. If a higher draw of direct current than the power bus is created to support, the power bus may fail, as such the future distribution of power may be negatively impacted.

For example, the power supply unit may be positioned at the bottom of the rack and the data processing systems positioned above the power supply unit within the rack. In this scenario, the distribution of power (e.g., current flow distribution) to the data processing systems may exceed the operation limits of the busbar (e.g., the bus bar is operating beyond operations limits) and as such, the likelihood of damage to the system may be increased.

For example, should the busbar be deprecated and/or otherwise damaged due to current flow distribution exceeding the operation limits of the busbar, the distribution of power may become inefficient, unpredictable, or irreparable without significant and/or time-consuming replacements to the rack system. For example, if the current flowing through the busbar exceeds operation limits of the busbar, heat may be generated and excessive heat may melt supporting plastic components, thus leading to electrical fires. Consequently, such services as the computer implemented services may thereby be delayed and/or prevented entirely.

To identify the causation of the current flow distribution exceeding the operation limits of the busbar, information from different components (e.g., data processing systems, servers, power shelves, etc.) in the rack may be provided to a management unit. To do so, communication cables may be needed to operably connect data processing systems positioned in the rack to facilitate communication between the data processing systems, power shelves, and/or any other components in the rack system. However, rack systems already are overwhelmed with the amount of communication cables used for providing supportive services (e.g., power supply, auxiliary components, etc.). Therefore, no effective mechanism to aggregate and/or centralize the data in a way to support real-time system-wide analysis while reducing other challenges (e.g., additional communication cables leading to complicated and expensive set up processes) may be provided.

To facilitate communication of the data in a rack system, a method for obtaining data to be transmitted to another device positioned in a rack based on identifying an occurrence of a communication event. The data may be transmitted to the other device by generating an acoustic signal to carry the data to the other device and coupling the acoustic signal to a busbar to generate an acoustic wave in the busbar. The busbar may be used as a communication medium in addition to utilizing it as a power distribution medium.

Thus, by utilizing the busbar as both a power distribution and a communication medium, information may be transmitted between the components of the rack system without adding additional communication cables. By doing so, monitoring of power distribution may be facilitated to prevent overloading and overheating of the system. In addition, imbalances in current distribution may be detected and corrective actions may be performed in order to prevent potential damage to the system. Therefore, reliability in rack-mounted power systems may be improved by communicating data regarding power distribution without disrupting operations.

In an embodiment, a method for managing data processing systems positioned in a rack is provided. The method may include: identifying, by a data processing system, an occurrence of a communication event; based on the occurrence of the communication event: obtaining, based on the occurrence and by the data processing system, data to be transmitted to another device positioned in the rack; generating, by the data processing system, an acoustic signal to carry the data to the other device; coupling, by the data processing system, the acoustic signal to a busbar to generate an acoustic wave in the busbar to provide the data to the other device, the busbar being adapted to distribute power to the data processing systems positioned in the rack.

Generating the acoustic signal may include: applying an electric signal to an acoustic module to generate the acoustic signal.

Generating the acoustic signal may also include: obtaining, by the data processing system, the data to transmit to the other device; encoding the data onto a signal; and using the signal to drive an analog circuit to obtain the electric signal, wherein the acoustic module comprises a transducer that is activated by the electric signal.

Coupling the acoustic signal to the busbar may include: flowing the acoustic signal from the transducer through an acoustic coupler to the busbar.

The acoustic module may be positioned with a bar clip through which the data processing system receives power from the busbar.

The coupler may be an off-angle coupler to induce a traveling acoustic wave along a length of the busbar.

The method may also include: receiving, by the data processing system from the other device, the acoustic wave back from the busbar after reflecting from a top portion of the busbar; transferring, by the data processing system, the acoustic wave into the acoustic signal to obtain the data; and identifying an action set to perform based at least on the data.

Identifying the occurrence of the communication event may include: identifying, by the data processing system, power supply information, the power supply information comprising at least an amount of power available for the data processing systems positioned in the rack; and identifying, based at least on the power supply information, insufficient information necessary to perform a power control process by the data processing system.

Identifying the occurrence of the communication event may also include: identifying, by the data processing system, that a new workload has been received; and identifying, based at least on the new workload, that an increase in power consumption for the data processing system is necessary to perform the new workload.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

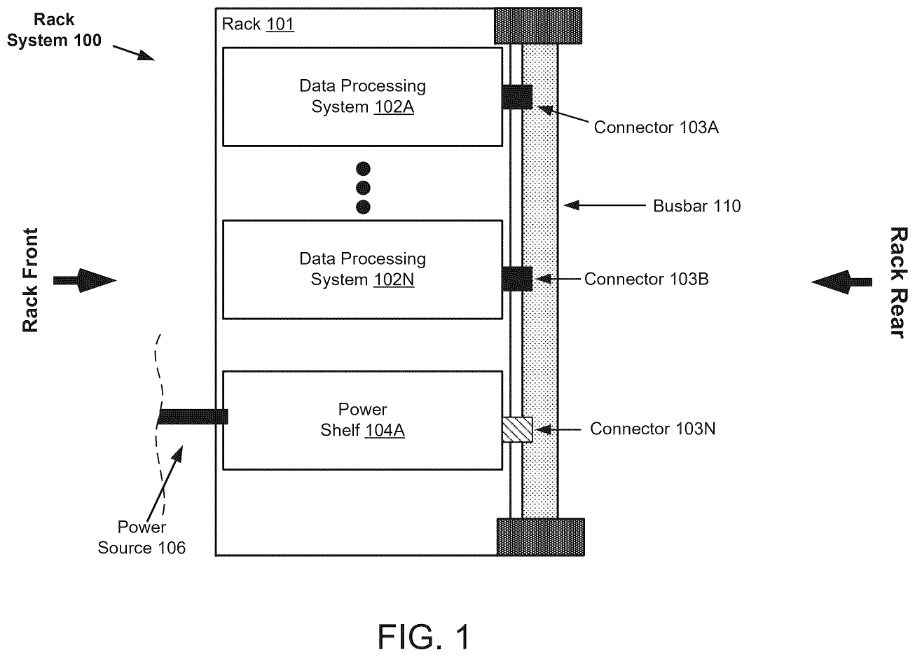

Turning to FIG. 1, a block diagram illustrating a system (e.g., rack system 100) in accordance with an embodiment is shown. The system shown in FIG. 1 may be a distributed system that provides computer implemented services.

These services may include any type and/or quantity of services. These services may include, for example, database services, data processing services, electronic communication services, and/or any other services that may be provided by one or more computing devices.

Other types of services may be provided by the system shown in FIG. 1 without departing from embodiments disclosed herein.

To provide these services, the system may include any number of data processing systems (e.g., computing devices), such as data processing systems 102A through 102N, positioned in a rack (e.g., 101) as shown in FIG. 1. Each of these data processing systems may include any quantity of hardware components. These components may include, for example, processors, memory modules, storage devices, communications devices, and/or any other type of component whose respective operation may facilitate various functionalities of the data processing systems. By facilitating such functionalities of the data processing systems, operation of any of these components may cause the services to be provided.

To enable such operation of the hardware components, the hardware components may consume power required for such operation. This power may be provided by one or more power supply units, such as any number of power supply units positioned in an enclosure (e.g., a chassis) of a power shelf. For example, this power shelf may be one of any number of power shelves (e.g., 104A through 104N) positioned in rack 101 that may collectively provide power to a power bus (e.g., busbar 110) positioned towards a rear of rack 101. This power bus, once provided the power, may redistribute the power to any number of chassis positioned in rack 101, each of these chassis at least partially housing at least one of the data processing systems.

However, any number of power supply units and/or the power bus may be subjected to any number of unpredictable events, such as events that may negatively impact future distribution of power.

For example, should connections between the power bus and any of the chassis be deprecated and/or otherwise damaged, power components responsible for the distribution of power may become inefficient, unpredictable, and/or irreparable without significant and/or time-consuming replacements to the rack system. Consequently, should the power required for enabling such operation to be inconsistently available (e.g., due to the deprecation and/or any occurrence of damage), if available at all, the data processing systems may not be capable of drawing power required to enable respective operation and/or may not be capable of otherwise providing the computer implemented services. Such services may thereby be delayed and/or prevented entirely.

For example, a significant issue may arise when the power bus (e.g., busbar 110), responsible for delivering the power across a rack of data processing systems and power shelves, becomes overloaded (e.g., when busbar draws more current than it is designed to handle). If too much power is drawn, for example, thermal runaway may occur, thereby risking excessive heat, equipment failure, and/or other negative impacts to the system. While individual current sensors may measure the variable amount of current drawn by each device (e.g., data processing systems, power shelves, etc.) within a rack system, an effective mechanism to aggregate and/or communicate this data may be lacking and/or necessary for determining total current flow distribution and/or providing timely responses to manage system overloads.

To increase a likelihood of providing computer implemented services as expected and/or desired by a consumer of such services (e.g., an entity associated with the data processing systems in the rack), and decrease a likelihood of systems that may provide such services being negatively impacted, a distributed system (e.g., rack system 100) may include components such as those illustrated and discussed with regard to FIG. 1, below.

In general, embodiments disclosed herein relate to systems, devices, and methods for managing operation of data processing systems positioned in a rack system that may provide computer implemented services is provided. To do so, a communication framework may be leveraged. This leveraging, for example, may include utilizing a busbar to provide ultrasonic communication between components within a rack system. The busbar may be used as a power distribution medium as well as a communication medium.

This communication framework may include (i) identifying an occurrence of a communication event by a data processing system within the rack, (ii) obtaining the data to be transmitted to another device positioned in the rack, (iii) generating an acoustic signal to carry the data to the other device, (iv) coupling the acoustic signal to the busbar to generate an acoustic wave in the busbar to provide the data to the other device, (v) upon the other device receiving the data (e.g., via receiving the acoustic signal), using the data to prepare the rack system and/or components of the rack system for the intended operation, and (vi) facilitating provisioning of desired computer implemented services using the powered rack system.

Therefore, this communication framework may decrease a likelihood of a rack system (e.g., 100) being negatively impacted by power distribution issues, system overloads, etc. More specifically, for example, power usage data between components of the rack system may be more likely to be communicated in order to detect power anomalies and adjust power loads in a timely-manner when this communication framework is facilitated.

To provide the above noted functionality, the rack system of FIG. 1 (e.g., 100) may include rack 101, data processing systems 102A-102N, connectors 103A-103N, power shelf 104A, and/or busbar 110. Each of these is discussed below.

It will be appreciated that even though illustrated to include just two data processing systems (e.g., 102A and 102N), the system of FIG. 1 may include any number of data processing systems (e.g., 102A through 102N) not to be limited by embodiments discussed herein. Any of these systems may (i) include hardware components that consume power to facilitate respective operation, (ii) depend on a power source, such as one or more power shelves (e.g., 104A through 104N) and/or a power distributor (e.g., busbar 110), to provide the power, (iii) be stacked vertically with regard to one another in vertically aligned slots of rack 101, and (iv) provide computer implemented services based on respectively facilitated operation of the hardware components.

To provide their functionality, data processing systems 102A and 102N may be implemented by, for example, two computing devices such as servers positioned (e.g., stacked) vertically in rack 101 with one another. For example, the rack may include a series of slots that are vertically positioned relative to one another (e.g., the vertically aligned slots), and each data processing system may be at least partially housed in a respective chassis adapted to be inserted into one of the slots, each chassis being further adapted to house hardware components of a respective data processing system.

As mentioned above, these data processing systems (102A and 102N) may include management controllers. These management controllers may facilitate operation of the corresponding hardware components by (i) providing instructions/commands for the hardware components as well as (ii) facilitating communications with other devices.

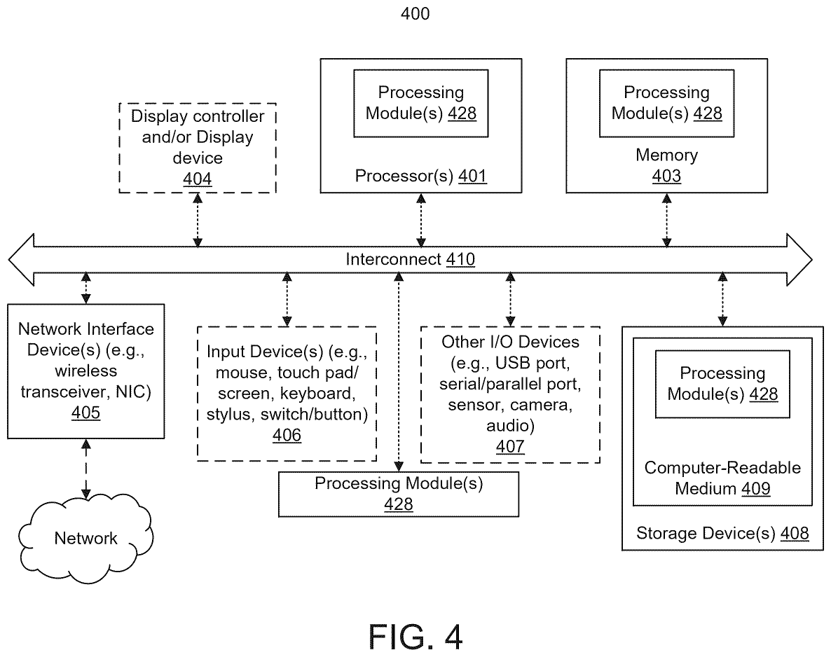

For additional information regarding data processing systems, refer to FIG. 4.

It will be appreciated that even though illustrated in FIG. 1 to include just one power shelf (e.g., 104A), the system of FIG. 1 may include any number of power shelves (e.g., 104A through 104N) not to be limited by embodiments discussed herein. Any of these power shelves may (i) include any number of power supplies, and (ii) provide power to the power bus (e.g., busbar 110).

To provide its functionality, power shelf 104A may be operably connected to power source 106 (e.g., any type of power source) and may be implemented by enclosures (e.g., other/additional chassis) adapted to house and secure power supply units that may be positioned within their respective interiors. These enclosures may also facilitate, at least in part, physical connection with, for example, the power bus (e.g., the power bus being positioned and adapted to relay (provide) power to the rest of rack system 100).

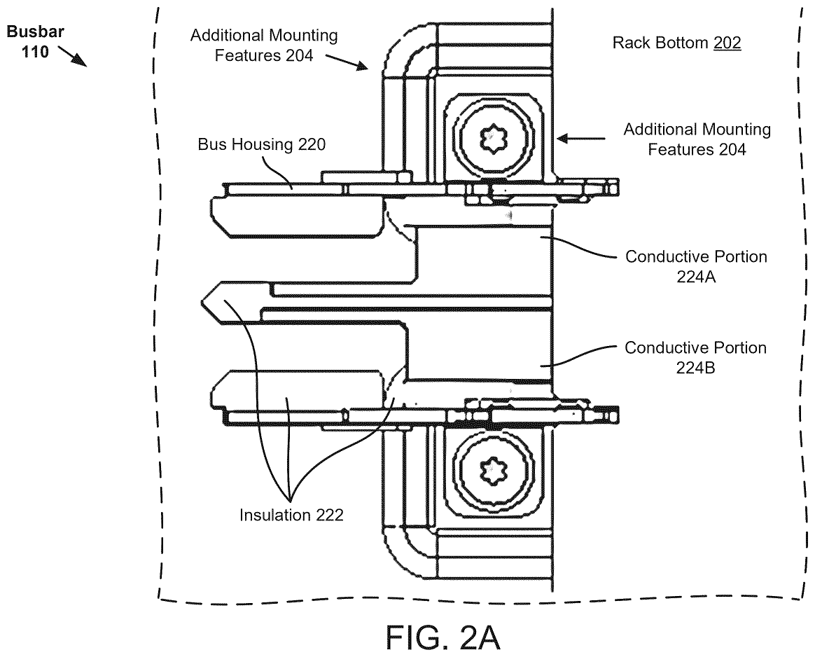

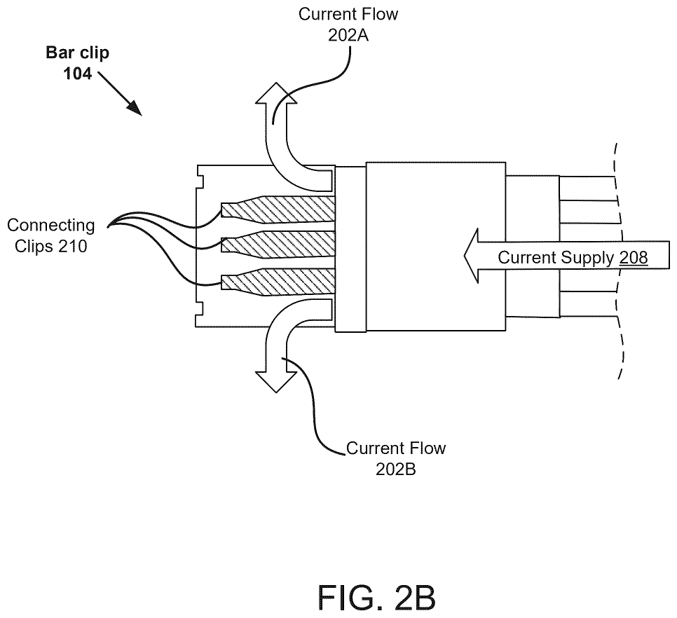

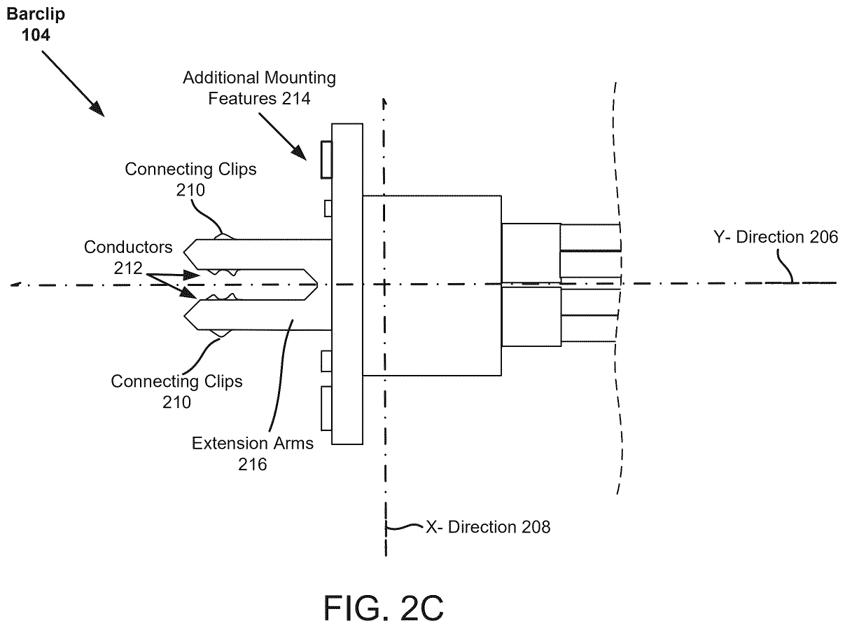

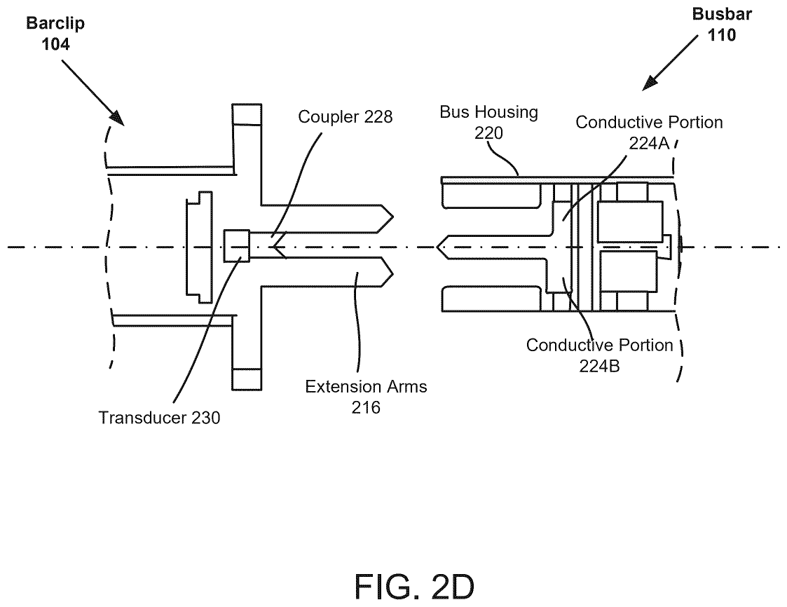

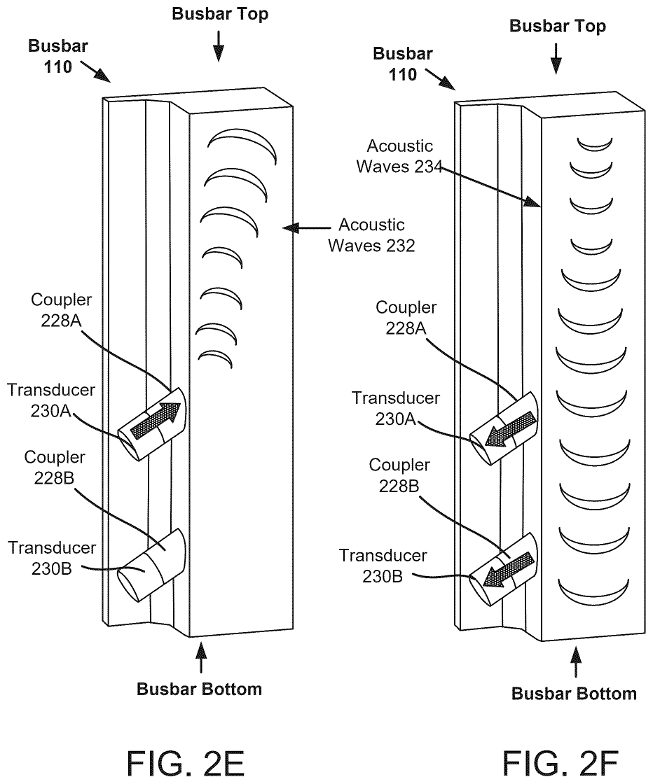

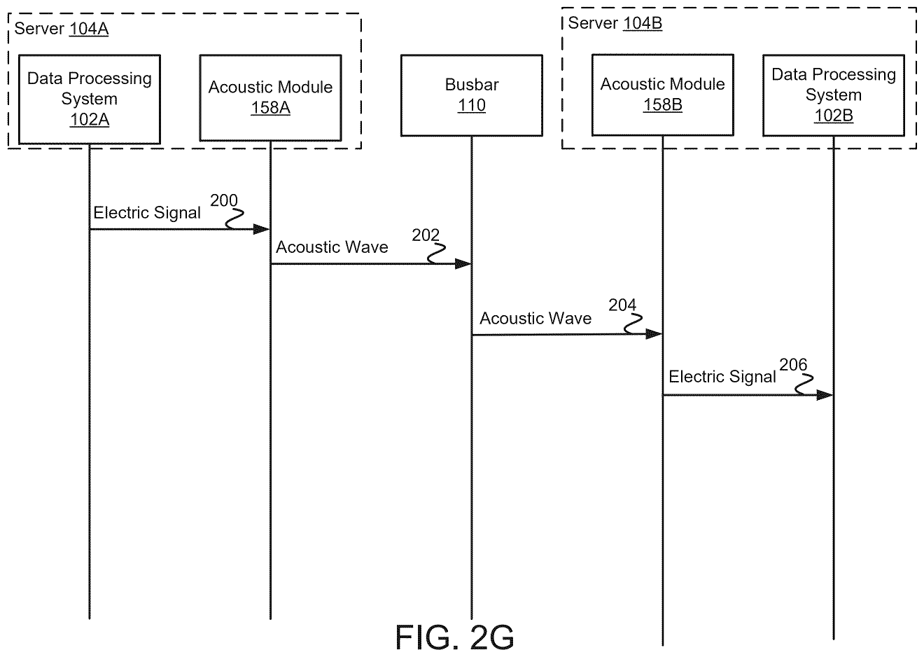

To further facilitate the connections between the power bus and the chassis housing the data processing systems and/or the other chassis housing power supply units, rack system 100 may include (i) first power connection (e.g., connector 103N) that enables the provision of power to the power bus from the power shelf, and (ii) second power connections (e.g., connectors 103A-103B) that enable distribution of the provided power to the data processing systems (e.g., that enable the hardware components to draw power as needed). Although referred in FIG. 1 as “connectors”, it may be appreciated that these power connections in rack system 100 may be referred as “bar clips” (e.g., bar clip 104). Refer to FIGS. 2B-2C for additional information regarding an individual bar clip.

It will be appreciated, that although discussed with regard to rack system 100 including these power connections, (i) any one of the first power connection may be included in, and/or may be extensions of, the other chassis housing power supply units, and (ii) any one of the second power connections may be included in, and/or may be extensions of, the chassis housing hardware components of the data processing systems.

To provide their functionalities, these power connections may be implemented by conductive materials shaped (and/or otherwise formed) to facilitate physical contact with other conductive materials so as to provide a path for power distribution between components of rack system 100, thereby contributing to the power buss'facilitation of power distribution throughout rack system 100.

The power bus (e.g., busbar 110) may, as previously discussed, (i) distribute power provided by the power shelves, (ii) enable the data processing systems (and therefore components thereof) to draw the power provided by the power shelves, and (iii) be positioned with the rear of rack 101.

To further facilitate the distribution of power, the power bus may (iv) be positioned in a first position wherein the power connections (e.g., 103A-103N) are in direct physical contact with busbar 110 while the chassis of both the data processing systems and the power shelves are in operable positions within rack 101 (e.g., positioned in slots of rack 101 and pushed towards the rack rear within those slots). For example, data processing systems 102A and 102N and power shelf 104A are depicted in FIG. 1 at their operable positions.

It will be appreciated that, as shown in FIG. 1, while in respective operable positions in rack 101, corresponding power connections of respective chassis may have physical contact with busbar 110. Alternatively, as shown in FIG. 1, a power connection (e.g., connector 103N) may not make physical contact with busbar 110 if a corresponding chassis (e.g., power shelf 104A) is not in its respective operable position, the operable positions being at the rear of rack 101 (e.g., placed into the slots and pushed a far toward the rear of rack 101 as possible).

As previously mentioned, however, power components such as the power supply units, power connections, and/or the power bus may be subjected to any number of unpredictable events, such as events (e.g., overload of the system) that may negatively impact future distribution of power.

For example, should connections between the power bus and any of the chassis, such as the power connections discussed above, be deprecated and/or otherwise take damage and/or inflict damage (e.g., inflict damage on busbar 110), power components such as the power bus may, with regard to power distribution functionality, become inefficient, unpredictable, and/or irreparable without significant and/or time-consuming replacements to the rack system.

Such deprecation and/or damage may, for example, occur during operation of rack system 100 (e.g., power being supplied to rack system 100). In such cases of the power distributing functionality being negatively impacted, rack system 100's capability of providing computer implemented services may result in such services instead being delayed and/or prevented entirely.

In an attempt to prevent such negative impacts, the power bus may also (v) be adapted for repositioning between the first position and a second position in which the power connections (e.g., 103A-103N) do not make physical contact with the power bus (e.g., busbar 110) while the chassis of both the data processing systems and the power shelves are in the operable positions within rack 101. To provide its functionality, the power bus may be implemented by busbar 110.

It will be appreciated that busbar may include any number of sub-portions not to be limited by embodiments discussed herein. For example, these sub-portions may be separated by any distance from one another while still being part of rack system 100. For example, as shown in FIG. 1, busbar may include two sub-portions (e.g., a top sub-portion that is proximate to a rack ceiling of rack 101, and a bottom sub-portion that is proximate to a rack bottom of rack 101), each being located on opposite ends of busbar 110 from one another.

By including the aforementioned (e.g., discussed above) components, rack system 100 may enable the leveraging of the communication framework. In doing so, the likelihood of the rack system providing the computer implemented services as intended may thereby be increased.

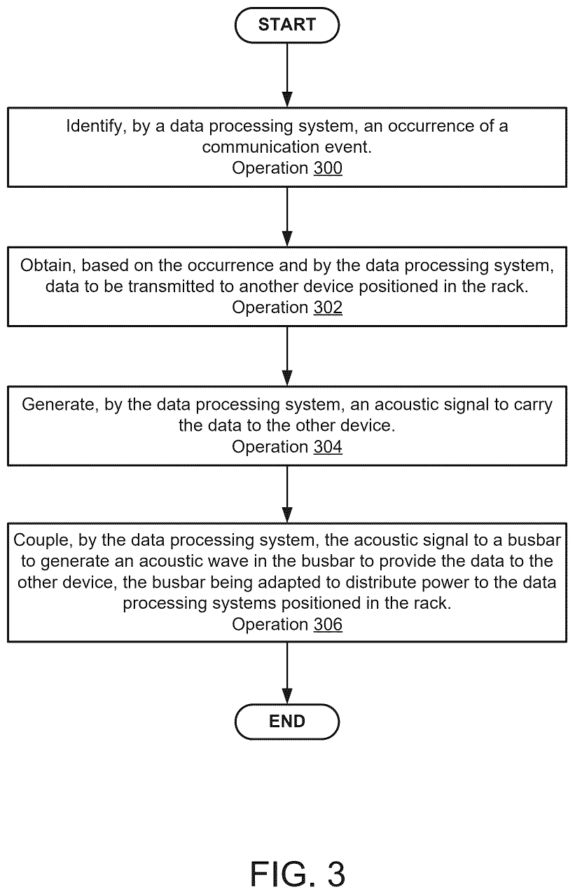

When providing their functionality, rack 101, data processing systems 102A-102N, connectors 103A-103N, power shelf 104A, and/or busbar 110 may perform (and/or be involved in) all, or a portion, of the method shown in FIG. 3.

Any devices (and/or components thereof) included in the system of FIG. 1 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system.

For additional details regarding computing devices, refer to FIG. 4.

Any of the components illustrated in FIG. 1 may be operably connected to each other (and/or components not explicitly illustrated) with a communication system utilized by data processing systems 102A-102N and/or other devices included in rack system 100.

In an embodiment, this communication system may include one or more networks that facilitate communication between any number of components. The networks may include wired networks and/or wireless networks (e.g., and/or the Internet). The networks may operate in accordance with any number and types of communication protocols (e.g., such as the internet protocol).

Thus, by utilizing a busbar as a communication medium in addition to a power distribution medium to data processing systems and power shelves positioned in a rack system, data may be transmitted between the devices of the rack system in a timely manner. By doing so, system operations (e.g., power distribution anomalies, power loads, etc.) may be managed. For example, monitoring of current distribution may be facilitated to prevent overloading and overheating of the system. In addition, imbalances in current distribution may be detected and corrective actions may be performed in order to prevent potential damage to the system. Therefore, reliability in rack-mounted power systems may be improved by providing accurate current measurement without disrupting operations.

While illustrated in FIG. 1 as including a limited number of specific components, a system (e.g., the rack system) in accordance with an embodiment may include fewer, additional, and/or different components than those illustrated therein.

To further clarify embodiments disclosed herein, diagrams illustrating examples of a rack system (and/or portions thereof) in accordance with embodiments are shown and discussed with regard to FIG. 2A. Furthermore, diagrams illustrating examples of a bar clip in accordance with embodiments are shown and discussed further below with regarding to FIGS. 2B-2E.

Turning to FIG. 2A, a structural diagram in accordance with an embodiment is shown. The structural diagram may illustrate a top-down view (with a top side of rack bottom 202 facing out of the page and the rack rear facing a bottom of the page) of that depicted in FIG. 1. This top-down view may be used to clarify an orientation of busbar 110 with an embodiment.

For example, while in the second position, busbar 110 may be oriented such that the housing of busbar 110 may be fasten-able via the bolts and/or bolt holes of additional mounting features 204. These bolts and bolt holes may be used to, for example, fixedly secure the bottom of busbar 110 into the page, and therefore, fixedly secure busbar 110 to rack bottom 202.

Additionally, conductive surfaces of busbar 110 may not face directly toward the power connections (positioned outside a viewpoint of FIG. 2G and toward a top of the page) as they would normally do when busbar 110 is in functional position to facilitate the distribution of power when the power connections make physical contact with busbar 110. This may be due to the conductive surfaces of busbar 110 needing to face the power connections should physically contact with the power connections be intended/required.

For example, to provide its functionality, busbar 110 may include bus housing 220, insulation 222, conductive portion 224A, and conductive portion 224B. Each of these is discussed below.

As previously discussed, the housing of busbar 110 may be fasten-able via the bolts and/or the bolt holes of additional mounting features 204. For example, this housing may be implemented by bus housing 220.

Bus housing 220 may, for example, (i) at least partially house insulating and/or conductive materials of busbar 110, (ii) provide a stable (e.g., unmalleable) structure for busbar 110, the structure being adapted to maintain a relative shape of busbar 110 (e.g., before, during, and after deployment), (iii) have a general shape, extended members, and/or other characteristics adapted to interact with relocation mechanism 112 to facilitate attachment and/or detachment of busbar 110 to and/or from rack bottom 202, (iv) facilitate and/or prevent deliberate (e.g., specific) physical contact between housed portions of busbar 110 and the power connections based on a position of busbar 110 and positions of the chassis in rack 101.

To provide its functionality, bus housing 220 may be implemented by an enclosure that at least partially surrounds the insulating and conductive portions of busbar 110. For example, bus housing 220 may be of a same material as that of the chassis positioned in rack 101.

Insulation 222 may include any number of materials positioned between bus housing 220 and the conductive portions of busbar 110. For example, the insulating materials may be adapted to prevent an electrical current from traveling between bus housing 220 and the conductive portions, thereby limiting a traversal path of any electrical current traversing through busbar 110 to an intended and/or predictable path. For example, by being limited to this path, an entity (and/or other components in a shared environment of the rack system) may be less likely to be negatively impacted in a physical manner (e.g., a manner resulting in injuries to the client and/or damages to the rack system).

To provide its functionality, insulation 222 may be implemented by insulating materials that prevent and/or are otherwise maladapted for conducting electricity.

Conductive portions 224A and 224B may obtain power provided by the power shelves and/or distribute that power throughout the rack system. For example, conductive portion 224A may be adapted to facilitate the obtaining of the power, and conductive portion 224B may be adapted to redistribute the obtained power to the data processing systems in rack 101.

It will be appreciated that, while power is being collaboratively distributed by these conductive portions, any one of the two conductive portions may be the actual (and sole) distributor of the obtained power while the other of the two conductive portions may be the sole facilitator of the obtaining of the power in an embodiment.

To provide their functionalities, conductive portions 224A-224B may be implemented by conductive materials that promote and/or may otherwise be adapted for conducting electricity.

Turning to FIG. 2B, a first diagram illustrating a side view of a bar clip (e.g., 104, an example of the previously mentioned bar clip) in accordance with an embodiment is shown.

Bar clip 104 may facilitate power distribution by providing a secure connection between a bus bar (e.g., bus bar 110) and a power supply (e.g., power shelf 104A shown in FIG. 1). For example, bar clip 104 may provide electricity supplied by a power shelf (e.g., power shelf 104A shown in FIG. 1 as previously mentioned) to busbar 110.

To securely connect to busbar 110, bar clip 104 may include connecting clips 210. Connecting clips 210 may align with the tips of the busbar (e.g., bus housing 220 of busbar 110 shown in FIG. 2A) such that bar clip 104 may be adapted to fasten to busbar 110. Connecting clips 210 may include, for example, a clamping feature designed to securely fix opposing interconnects for two extension pole connections of busbar 110 to extension arms 216 of bar clip 104. Refer to FIG. 2C for additional details regarding connecting clips of a bar clip.

To facilitate the distribution of power to the data processing systems via the power bus (e.g., busbar 110), a supply of current (e.g., current supply 208) may flow from the power shelf (e.g., power shelf 104A) into bar clip 104. Current supply 208 may enter bar clip and flow in multiple directions. The actual current flowing through different sections of the busbar may vary depending on the distribution of load across the rack. For example, if the power shelf is positioned in the middle of the rack (e.g., with data processing systems positioned above and below the power shelf), the current flow may split into two directions, with one current flow directed above the bar clip (e.g., current flow 202A as indicated by the direction of the arrow pointing upward toward the top of the paged) and a second current flow directed below the bar clip (e.g., current flow 202B as indicated by the direction of the arrow pointing downward toward the bottom of the page).

Measuring the total current coming out of the power shelf may not indicate how the current is distributed along busbar 110, thereby increasing the difficulty in preventing overloads and increasing a likelihood of causing damage to the system. To accurately measure (and therefore manage) the current flow distributed along the busbar, bar clip 104 may include sensors positioned on opposite sides of a current injection point (e.g., point of current supply 208 via power shelf 104A). The sensors may include, for example, hall sensors embedded in bar clip 104 to measure the magnetic flux density generated by respective currents at two different distributions points.

For example, a first sensor may be positioned at the top of bar clip 104 in order to measure the magnetic flux density generated by the flow of current directed upwards (e.g., above the current injection point). For example, if the current flow is directed upwards, a first measurement of the magnetic flux density generated may rotate in a counter-clockwise motion relative to the z-axis.

A second sensor may be positioned at the bottom of bar clip 104 in order to measure the magnetic flux density generated by the flow of current directed downwards (e.g., below the current injection point). For example, if the current flow is directed downwards, a second measurement of the magnetic flux density generated may rotate in a clockwise motion relative to the z-axis.

The rate of current injection (e.g., current from the power shelf) and the two measurements of magnetic flux density may be used to calculate a first current flow rate and first current flow direction (e.g., current flow 202A) and a second current flow rate and second current flow direction (e.g., current flow 202B). For example, the difference between the magnitudes (e.g., of the magnetic flux density measurements obtained from the sensors) may provide the correct magnetic flux density contribution of the current flowing in busbar 110 resulting from current supply 208. The sensors may measure the magnetic flux density (“B”) which may be proportional to the current (“I”) flowing through the busbar at the respective locations (B~I).

Current flow 202A and current flow 202B may be used to obtain the current flow distribution (e.g., the distribution of current) along busbar 110. For example, to determine current distribution, Maxwell's equations as specified below may be used to derive the actual current flowing through each segment of busbar 110.

I₁ may be the total current from the power shelf.

I₂ may equal the current flowing up the busbar.

I₃ may equal the current flowing down the busbar.

Conservation of current: I₁=I₃−I₂.

B2 may be the magnetic flux density measured by sensor positioned at the top of the bar clip.

B3 may be the magnetic flux density measured by sensor positioned at the bottom of the bar clip.

Noise provided by common mode sources (CM) may be considered.
k may be a constant related to the busbar type/size (e.g., providing rate capacity)
B2=k*I₂+CM noise
B3=k*I₃+CM noise
B3−B2=k*I₃−k*I₂+CM noise−CM noise
k*(I₃−I₂)=k*I₁
k=(B3−B2)/I₁

If the sensors detect that either I₂ and/or I₃ exceeds the busbar's rate capacity, a remedial action may be triggered. The collected data (e.g., current flow measurements) may be a part of the data communicated using the communication methods described in more detail in FIGS. 2E-2F. Refer to FIG. 2E for additional information regarding communication of data.

Turning to FIG. 2C, a second diagram illustrating a top-down view (with a top side of bar clip 104 facing out of the page, the rear side of bar clip 104 facing into the page, and a backside of the bar clip 104 facing the right side) of that depicted in FIG. 2B. This top-down view may be used to clarify an orientation of hall sensors positioned within the bar clip (e.g., bar clip 104) with an embodiment.

As previously discussed, bar clip 104 may facilitate power distribution by providing a secure connection between a bus bar (e.g., bus bar 110) and a power supply (e.g., power shelf 104A shown in FIG. 1). To securely connect to busbar 110, connecting clips 210 may align with the tips of the busbar (e.g., bus housing 220 of busbar 110 shown in FIG. 2A) such that bar clip 104 may be adapted to fasten to busbar 110. Connecting clips 210 may include, for example, a clamping feature designed to securely fix opposing interconnects for two extension pole connections of busbar 110 to extension arms 216 of bar clip 104.

Bar clip 104 may also include conductors 212 positioned along an inside portion of extension arms 216. Conductors 212 may be integrally formed within both internal sides of extension arms 216. Conductors 212 may include, for example, any type of high-conductivity materials (e.g., copper, aluminum, etc.) designed for high-current applications. When busbar 110 is connected to bar clip 104, conductors 212 may provide the incoming electrical current (e.g., current supply 208) from the power shelf to the busbar 110 (e.g., via conductive portion 224A-224B of busbar 110 as shown in FIG. 2A).

Turning to FIG. 2D, a third diagram illustrating a top-down view of bar clip 104 and busbar 110 (with a top side of bar clip 104 and busbar 110 facing out of the page, and the rear side of the bar clip 104 and busbar 110) is shown. This top-down view may be used to clarify an orientation of a bar clip (e.g., bar clip 104) when mating with a busbar (e.g., busbar 110).

Bar clip 104 may include coupler 228. Coupler 228 may include any type of device adapted to couple a material or object to another portion of bar clip 104 in order to inject and/or receive electric signals as previously described above. For example, coupler 228 may electrically isolate transducer 230 from busbar 110 through which high voltage of electricity may be flowing. Coupler 228 may include an electrically insulating (e.g., non-conducting) interface that enables capacitive or inductive coupling to transducer 230, thereby allowing signal transmission without a direct conductive electrical connection to busbar 110. For example, coupler 228 may facilitate the transmission of the electric signal into an acoustic wave in busbar 110.

Transducer 230 may include any type of transducer configured to interact with busbar 110 (e.g., via capacitive, inductive, or acoustic coupling) when bar clip 104 is positioned to mate (e.g., physically connect) with busbar 110, without requiring a direct electrical connection. For example, transducer 230 may include a piezoelectric transducer that generates an electric signal to transmit to coupler 228. Transducer 230 may transmit acoustic signals into the busbar (e.g., busbar 110), which travels to other transducers connected to other devices positioned in a rack system. Refer to FIGS. 2E-2F for additional information regarding communication of acoustic signals.

Turning to FIGS. 2E-2F, diagrams illustrating transmission of data via acoustic signaling in accordance with an embodiment is shown. The diagrams may illustrate an isometric side view of a cross-section of a vertical busbar (e.g., busbar 110) in accordance with an embodiment. The diagrams may illustrate how ultrasonic communication may be established between devices (e.g., nodes) in a rack system using a busbar as the communication medium. For example, the diagrams may illustrate how ultrasonic signals are injected and detected along a busbar for the purpose of communication between devices in the rack.

As shown in FIGS. 2E-2F, the system may include transducers (e.g., transducer 230A-230B). Each transducer may be paired with a coupler (e.g., coupler 228A-228B) which interfaces with busbar 110. Each coupler may include any type of solid insulating material (e.g., plastic, rubber, etc.) which may influence the parameters such as the injection angle, mechanical fit, etc. Each coupler may be designed to electrically isolate the respective transducer from the busbar while allowing acoustic transmission. Each coupler may be designed to inject acoustic waves into busbar 110 at a specific angle. For example, coupler 228A may be mounted in such a way that the coupler is positioned at angle against busbar 110 to optimize injection and/or detection of ultrasonic waves.

The transducers and couplers may enable communication between nodes within a rack system by reading reflections and echoes of acoustic waves transmitted through the busbar. The transducers and couplers may be a part of the server chassis and/or respective bar clip (e.g., as shown in FIG. 2D) and may be spring-loaded against the busbar to maintain contact with the busbar.

It will be appreciated, that although shown in FIGS. 2E-2F and discussed with regard to a single individual transducer and coupler positioned at each node within a rack system, multiple transducers and/or couplers may be utilized at each node to communicate data between the devices of the rack system. For example, in systems with two nodes per unit, one node may use the positive busbar and the other node may use the return busbar and/or each node may time-share one transducer.

In order to transmit signals through the busbar, each device and/or node may: (i) generate digital data (e.g., information about power usage, thermal status, control commands, etc.), and (ii) encode the data into a format that may be converted into an acoustic signal. For example, this may be facilitated by a system interface (e.g., an Input/Output (“I/O”) port on a processor), which may output binary data (e.g., zeros and ones). The binary data may then be prepared for acoustic transmission using signal processing such as modulation and/or pulse shaping. For example, the system may modulate an amplitude of the ultrasonic wave over time to encode binary information. For example, a high amplitude pulse may represent a binary “1” and a low amplitude may represent a binary “0”. By utilizing amplitude modulation, the encoded signal may be transmitted as variations in ultrasonic wave energy.

The digital signal may be converted into an analog signal (e.g., via a signal processing chip) which may drive the transducer to transform the electrical signal into an acoustic and/or ultrasonic wave. As shown in FIG. 2E, transducer 230A may inject acoustic waves (e.g., acoustic waves 232) at a specific angle into the busbar. Acoustic waves 232 may include longitudinal ultrasonic waves (e.g., propagating upwards through the busbar toward the top of the busbar). For example, acoustic waves 232 may be depicted as an arc shaped or ripple-like shapes to indicate the upward movement of the ultrasonic wave towards the busbar top as shown in FIG. 2E.

The longitudinal acoustic waves may propagate along the length of the busbar (e.g., busbar 110), reflecting off boundaries (such as the busbar top and/or busbar bottom as shown in FIGS. 2E-2F). Busbar 110 may act as a communication channel by enabling the acoustic waves to travel between transmitting and receiving transducers. As shown in FIG. 2F, when acoustic waves 232 reach the top end of busbar 110, the acoustic waves may reflect back down the busbar toward other nodes along the busbar. For example, the reflected waves (e.g., acoustic waves 234) from the busbar top are detected by another transducer (e.g., transducer 230B). The second transducer (e.g., transducer 230B) may receive the ultrasonic waves (e.g., acoustic waves 234) via coupler 228B. The receiving transducer (e.g., 230B) may detect the incoming acoustic wave and may convert the acoustic wave back into an electrical signal.

Once the received signal is digitized, the system (e.g., device) may use digital signal processing to: (i) detect known patterns or pseudo-noise “PN” codes to identify valid messages, (ii) demodulate the signal, and/or (iii) extract the original binary data (e.g., the current draw, temperature readings, or control instructions). By doing so, devices in the rack system may perform actions based on the data (e.g., reduce power consumption), forward data to a central controller (e.g., management unit), and/or improve a likelihood of managing operation of data processing systems position in the rack in order to provide the desired computer implemented services.

To further clarify embodiments disclosed herein, interaction diagrams in accordance with an embodiment are shown in FIG. 2G. The interaction diagrams may illustrate how data may be obtained and used within the system of FIGS. 1A-2F.

In the interaction diagram, processes performed by and interactions between components of a system in accordance with an embodiment are shown. In the diagram, components of the system are illustrated using a first set of shapes (e.g., 190, 191, etc.), located towards the top of each figure. Lines descend from these shapes. Processes performed by the components of the system are illustrated using a second set of shapes (e.g., 200, 210, etc.) superimposed over these lines.

Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 204. However, it will be appreciated that the processes and interactions may be performed in different orders, any may be omitted, and other processes or interactions may be performed without departing from embodiments disclosed herein.

The lines descending from the first set of shapes (e.g., other hardware components 164) are drawn in dashes to indicate, for example, that the corresponding components may not be (i) operable, (ii) powered on, (iii) present in the system, and/or (iv) not participating in operation of the system for other reasons.

The processes shown in FIG. 2G may be performed by any entity shown in the systems of FIGS. 1-2F (e.g., a device similar to data processing system 102A, a device similar to power shelf104A, etc.) and/or another entity without departing from embodiments disclosed herein.

Turning to FIG. 2G, a first interaction diagram in accordance with an embodiment is shown. The interaction diagram may illustrate processes and interactions that may occur during communication of data between components positioned in a rack when a communication even is identified to have occurred.

To identify that a communication event has occurred, information necessary to perform certain processes by a data processing system may be obtained. For example, power supply information may be identified during startup of a data processing system and in order to perform power control processes, the data processing system may need information for power supply available to the data processing system from a power shelf.

At interaction 200, an electric signal may be provided to acoustic module 158A by data processing system 102. To provide the electrical signal to acoustic module 158A, the electrical signal may be generated by encoding digital data (e.g., via amplitude modulation), converting the digital data to analog signal (e.g., via passing the digital signal through a digital-to-analog converter), and/or be subjected to any further processing methods (e.g., signal conditional to amplify, filter, and/or match in impedance to the transducer). Once obtained, the analog signal may be provided to the ultrasonic transducer (acoustic module 158A). The electric signal may be generated based on digital data (e.g., encoded binary data generated via a system interface corresponding to the respective data processing system) that is converted to an analog signal and received by a transducer.

Once received by acoustic module 158A, at interaction 202, an acoustic wave may be provided to busbar 101 by acoustic module 158A. The acoustic wave may be provided to busbar 110 by: (i) converting the electric signal to the acoustic wave (e.g., high-frequency ultrasonic pulse), (ii) transferring the acoustic wave through an acoustic coupler into the surface of the busbar, and/or (iii) by any other methods. For example, acoustic module 158A may receive the electric signal from data processing system 102A and convert the electric signal into mechanical vibrations using piezoelectric or magnetostrictive principles. The mechanical vibrations may be transferred through the acoustic coupler into the busbar, thereby launching an acoustic wave into the material of the busbar (e.g., copper, metal, etc.).

At interaction 204, the acoustic wave may be provided to acoustic module 158B by busbar 110. The acoustic wave may be provided to acoustic module 158B by: (i) propagating along the length of busbar 110 (e.g., reflecting off boundaries such as the top or bottom of the busbar), (ii) receiving, by an acoustic coupler of the respective acoustic module (e.g., acoustic module 158B), the reflected acoustic wave as it travels through the busbar (e.g., busbar 110), and/or (iii) any other methods facilitating communication of acoustic waves via busbar 110.

Once the acoustic wave is received by acoustic module 158B, at interaction 206, an electric signal may be provided to data processing system 102B by acoustic module 158B. The electric signal may be provided to data processing system 102 by converting the acoustic wave back into the electric signal. Once the electrical signal is received by data processing system 102B, the received signal may be digitized (e.g., via digital signal processing) to extract the transmitted data (e.g., the current draw, temperature readings, control instructions, etc.). For example, the transmitted data may include instructions to the data processing systems to limit the power consumed by the respective data processing systems. By doing so, any violations to the system limits may be reduced and a likelihood of the negative impacts of the operation of the system may be decreased.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

While illustrated in FIGS. 2A-2G with a limited number of specific components, a system (e.g., a rack system) may include additional, fewer, and/or different components without departing from embodiments disclosed herein.

As discussed above, the components of FIGS. 1-2G may facilitate and/or perform various functionalities to manage a system that may include a rack for housing data processing systems. Managing operation of the rack may include communicating data between devices via a busbar and managing electrical current distribution specifically when using the busbar for power distribution.

As discussed above, the components of FIGS. 1-2G may facilitate and/or perform various functionalities to manage operation of a rack. FIG. 3 illustrates a method that may be facilitated and/or performed by the components of FIGS. 1-2G.

In the diagram discussed below and shown in FIG. 3, any of the operations may be repeated, performed in different orders, and/or performed in parallel with or in a partially overlapping in time manner with other operation.

Turning to FIG. 3, a flow diagram illustrating a method for managing operations of data processing systems positioned in a rack in accordance with an embodiment is shown. The method may be performed, for example, by a rack system (e.g., 100) and/or any other entity.

At operation 300, an occurrence of a communication event may be identified by a data processing system. The occurrence of the communication event may be identified by (i) identifying, by the data processing system, that information is needed from an external entity (e.g., remote from data processing system) in order to perform specific tasks. For example, during start up of the data processing system, information regarding power supply available to the data processing system from a power shelf in the rack may be identified as unavailable (e.g., unknown by the data processing system), and therefore, communication with other components within the rack system may be necessary to obtain the information.

Identifying the occurrence of the communication event may also include: (i) identifying, by the data processing system, that a new workload has been received, and (ii) identifying, based at least on the new workload, that an increase in power consumption for the data processing system is necessary to perform the new workload. For example, the data processing system may receive instructions to perform an analysis-based task and as such, the data processing system may need to increase the amount of power derived from power shelf via the busbar. Information regarding available power supply to the rack system by the power shelf in the rack system may be necessary in order to avoid overloading the system, for example.

At operation 302, data to be transmitted to another device positioned in the rack may be obtained. The data to be transmitted to another device may be obtained by the data processing system based on the occurrence of the communication event. The data to be transmitted to the other device may be obtained by (i) generating, by the data processing system, digital data, (ii) encoding the data into a format that may be converted into an acoustic signal, and/or (iii) by any other methods.

At operation 304, an acoustic signal to carry the data to the other device may be generated. The acoustic signal to carry the data to the other device may be generated by the data processing system. Generating the acoustic signal may include: (i) applying an electric signal to an acoustic module to generate the acoustic signal, (ii) obtaining, by the data processing system, the data to transmit to the other device, (iii) encoding the data onto a signal, (iv) using the signal to drive an analog circuit to obtain the electric signal, and/or (v) by any other methods.

At operation 306, the acoustic signal may be coupled to a busbar to generate an acoustic wave in the busbar to provide the data to the other device. The busbar may be adapted to distribute power to the data processing systems positioned in the rack. Coupling acoustic signal to the busbar may include flowing the acoustic signal from the transducer through an acoustic coupler to the busbar and/or any other methods. For example, the acoustic coupler may be positioned between the transducer and the busbar surface to allow the acoustic signal to pass efficiently from the transducer into the busbar and/or vice versa (e.g., from the busbar to the transducer).

The method may end following operation 306.

Thus, using the method illustrated in FIG. 3, embodiments disclosed herein may manage operation of data processing systems positioned in a rack to increase the likelihood of providing the computer implemented services as expected and/or desired by a client.

Any of the processes and/or components illustrated in and/or discussed with regard to FIGS. 1-3 may be implemented with and/or used in conjunction with one or more computing devices.

Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of data processing systems positioned in a rack, the method comprising:
identifying, by a data processing system, an occurrence of a communication event;
based on the occurrence of the communication event:
obtaining, based on the occurrence and by the data processing system, data to be transmitted to another device positioned in the rack;
generating, by the data processing system, an acoustic signal to carry the data to the other device;
coupling, by the data processing system, the acoustic signal to a busbar to generate an acoustic wave in the busbar to provide the data to the other device, the busbar being adapted to distribute power to the data processing systems positioned in the rack.

2. The method of claim 1, wherein generating the acoustic signal comprises:
applying an electric signal to an acoustic module to generate the acoustic signal.

3. The method of claim 2, wherein generating the acoustic signal further comprises:
obtaining, by the data processing system, the data to transmit to the other device;
encoding the data onto a signal; and
using the signal to drive an analog circuit to obtain the electric signal,
wherein the acoustic module comprises a transducer that is activated by the electric signal.

4. The method of claim 3, wherein coupling the acoustic signal to the busbar comprises:
flowing the acoustic signal from the transducer through an acoustic coupler to the busbar.

5. The method of claim 4, wherein the acoustic module is positioned with a bar clip through which the data processing system receives power from the busbar.

6. The method of claim 5, wherein the coupler is an off-angle coupler to induce a traveling acoustic wave along a length of the busbar.

7. The method of claim 1, further comprising:
receiving, by the data processing system from the other device, the acoustic wave back from the busbar after reflecting from a top portion of the busbar;
transferring, by the data processing system, the acoustic wave into the acoustic signal to obtain the data; and
identifying an action set to perform based at least on the data.

8. The method of claim 1, wherein identifying the occurrence of the communication event comprises:
identifying, by the data processing system, power supply information, the power supply information comprising at least an amount of power available for the data processing systems positioned in the rack; and
identifying, based at least on the power supply information, insufficient information necessary to perform a power control process by the data processing system.

9. The method of claim 1, wherein identifying the occurrence of the communication event comprises:
identifying, by the data processing system, that a new workload has been received; and
identifying, based at least on the new workload, that an increase in power consumption for the data processing system is necessary to perform the new workload.

10. A non-transitory machine-readable medium having instructions stored therein, which when executed by a processor, cause the processor to perform operations for managing operation of a data processing system: the operations comprising:
identifying, by a data processing system, an occurrence of a communication event;
based on the occurrence of the communication event:
obtaining, based on the occurrence and by the data processing system, data to be transmitted to another device positioned in the rack;
generating, by the data processing system, an acoustic signal to carry the data to the other device;
coupling, by the data processing system, the acoustic signal to a busbar to generate an acoustic wave in the busbar to provide the data to the other device, the busbar being adapted to distribute power to the data processing systems positioned in the rack.

11. The non-transitory machine-read medium of claim 10, wherein generating the acoustic signal comprises:
applying an electric signal to an acoustic module to generate the acoustic signal.

12. The non-transitory machine-readable medium of claim 11, wherein generating the acoustic signal further comprises:
obtaining, by the data processing system, the data to transmit to the other device;
encoding the data onto a signal; and
using the signal to drive an analog circuit to obtain the electric signal,
wherein the acoustic module comprises a transducer that is activated by the electric signal.

13. The non-transitory machine-readable medium of claim 12, wherein coupling the acoustic signal to the busbar comprises:
flowing the acoustic signal from the transducer through an acoustic coupler to the busbar.

14. The non-transitory machine-readable medium of claim 13, wherein the acoustic module is positioned with a bar clip through which the data processing system receives power from the busbar.

15. A data processing system, comprising:
a processor; and
a memory coupled to the processor to store instructions, which when executed by the processor, cause the processor to perform operations for managing operation of a rack, the operations comprising:
identifying, by a data processing system, an occurrence of a communication event;
based on the occurrence of the communication event:
obtaining, based on the occurrence and by the data processing system, data to be transmitted to another device positioned in the rack;
generating, by the data processing system, an acoustic signal to carry the data to the other device;
coupling, by the data processing system, the acoustic signal to a busbar to generate an acoustic wave in the busbar to provide the data to the other device, the busbar being adapted to distribute power to the data processing systems positioned in the rack.

16. The data processing system of claim 15, wherein generating the acoustic signal comprises:
applying an electric signal to an acoustic module to generate the acoustic signal.

17. The data processing system of claim 16, wherein generating the acoustic signal further comprises:
obtaining, by the data processing system, the data to transmit to the other device;
encoding the data onto a signal; and
using the signal to drive an analog circuit to obtain the electric signal,
wherein the acoustic module comprises a transducer that is activated by the electric signal.

18. The data processing system of claim 17, wherein coupling the acoustic signal to the busbar comprises:
flowing the acoustic signal from the transducer through an acoustic coupler to the busbar.

19. The data processing system of claim 18, wherein the acoustic module is positioned with a bar clip through which the data processing system receives power from the busbar.

20. The data processing system of claim 19, wherein the coupler is an off-angle coupler to induce a traveling acoustic wave along a length of the busbar.
